(19) United States
(12) Patent Application Publication
(10) Pub. No.: US 2023/0366487 A1
(43) Pub. Date: Nov. 16, 2023

(54) FLUID SUPPLY SYSTEM

(71) Applicant: SAMSUNG ELECTRONICS CO., LTD., Suwon-si (KR)

(72) Inventors: Dal Heo, Suwon-si (KR); Youngjin Park, Suwon-si (KR); Wooram Hong, Suwon-si (KR)

(73) Assignee: SAMSUNG ELECTRONICS CO., LTD., Suwon-si (KR)

(21) Appl. No.: 18/133,792

(22) Filed: Apr. 12, 2023

(30) Foreign Application Priority Data
May 16, 2022 (KR) 10-2022-0059460

(51) Int. Cl. F16L 3/01

(52) U.S. Cl. CPC F16L 3/012

(57) ABSTRACT

A fluid supply system may include: a tube configured to allow a fluid to flow through the tube; a housing including a storage space configured to store at least a portion of the tube, and an outlet which allows the tube to extend from the storage space; a support portion configured to support at least a portion of the tube in the storage space, and configured to move from an initial position of the support portion towards the outlet based on a degree of extension of the tube from the outlet; and a position maintaining portion connected to the support portion and configured to apply a restoring force to the support portion to return the support portion to the initial position.

### CROSS-REFERENCE TO RELATED APPLICATION

This application claims priority from Korean Patent Application No. 10-2022-0059460, filed on May 16, 2022, in the Korean Intellectual Property Office, the disclosure of which is incorporated herein by reference in its entirety.

### BACKGROUND

### 1. Field

Methods and apparatuses consistent with example embodiments relate to a fluid supply system.

### 2. Description of the Related Art

A supply line, such as a tube or a hose, may be used to supply a fluid to a target, and there is a desire for technology for increasing process efficiency by securing maintenance of the supply line.

### SUMMARY

According to an aspect of the present disclosure, a fluid supply device may include: a tube including a flexible material and configured to allow a fluid to flow through the tub; a housing including a storage space configured to store at least a portion of the tube, and an outlet which allows the tube to extend from the storage space; a support portion configured to support at least a portion of the tube in the storage space, and configured to move from an initial position of the support portion towards the outlet based on a degree of extension of the tube from the outlet; and a position maintaining portion connected to the support portion and configured to apply a restoring force to the support portion to return the support portion to the initial position.

The fluid supply device may further include: a fixing portion configured to support at least a portion of the tube at a fixed position in the storage space, wherein the fixing portion and the support portion may be configured to support different portions of the tube, respectively.

The support portion may move towards the fixing portion while the tube is being pulled out through the outlet.

A height of a portion of the tube supported by the fixing portion from a ground may be equal to a height of the outlet from the ground.

The support portion is disposed lower than the outlet from a ground.

When the tube is pulled out though the outlet, the support portion rises from the initial position in a direction opposite to a direction of gravity, and the position maintaining portion may be configured to apply a force to the support portion in the direction of gravity.

The position maintaining portion may include an elastic member connected to the support portion, and the elastic member may be configured to store an elastic force while the support portion moves from the initial position and apply the restoring force to the support portion to return the support portion to the initial position through the elastic force.

The position maintaining portion may further include: a first magnetic member connected to the support portion; and a second magnetic member magnetically coupled to the first magnetic member, wherein the first magnetic member and the second magnetic member may be configured to apply a magnetic force to each other to return the support portion to the initial position.

The position maintaining portion may further include: a rotating member configured to rotate; a tension member wound around the rotating member and connected to the support portion; and an actuator connected to the rotating member and configured to rotate the rotating member to return the support portion to the initial position.

The fluid supply device may further include a plurality of support portions, wherein the plurality of support portions are configured to move from initial positions of the plurality of support portions towards the outlet while supporting different portions of the tube in a process of drawing out the tube, and the plurality of support portions are respectively connected to a plurality of position maintaining portions configured to return the plurality of support portions to the initial positions of the support portions.

The fluid supply device may further include a guide rail provided in the storage space and configured to guide a movement of the support portion.

The fluid supply device may further include: a dispenser head connected to a first end portion of the tube; and a mounting portion which is provided on an outer surface of the housing and on which the dispenser head is mounted.

The fluid supply device may further include a guide member disposed at the outlet and configured to reduce a frictional force caused by a movement of the tube through the outlet.

The fluid supply device may further include a sensor configured to sense a movement of the tube that is pulled out and pulled in through the outlet.

The housing may further include an opening provided on an outer surface of the housing and through which the tube extends from the storage space to an outside, wherein the opening may be at a same height as the outlet from a ground.

According to another aspect of the present disclosure, a fluid supply system may include: a plurality of fluid supply devices detachably interconnected with each other in a horizontal direction or a vertical direction and configured to individually supply a fluid, wherein each of the plurality of fluid supply devices may include: a tube including a flexible material, and configured to allow the fluid to flow through the tube; a dispenser head connected to an end portion of the tube; a housing including a storage space configured to store at least a portion of the tube, and an outlet which allows the tube to extend from the storage space or retracted into the storage space from an outside; a support portion configured to support a portion of the tube in the storage space, and configured to move based on a degree of extension of the tube from the outlet; and a position maintaining portion connected to the support portion and configured to apply a restoring force to the support portion to return a portion of the tube pulled out to the outside is retracted into the storage space.

When the tube is pulled out from the storage space by an external force, the support portion is configured to move from an initial position of the support portion toward the outlet, and when the external force is released, the support portion is configured to move to the initial position by the restoring force of the position maintaining portion.

The position maintaining portion may be configured to apply the restoring force to the support portion through at least one of an elastic force, the gravity, a magnetic force, an electromagnetic force, and an electric force.

Each of the plurality of fluid supply devices may further include a fixing portion positioned in the storage space and configured to support at least a portion of the tube at a different position from the support portion, and the fixing portion may be configured to support the tube in a fixed position in the storage space.

According to another aspect of the present disclosure, a fluid supply device may include: a tube; a dispenser head connected to an end portion of the tube; a housing configured to store the tube, and including an outlet that allows the tube to be pulled out from and pushed back into the housing; a drum configured to hold at least a portion of the tube being wound around an outer surface of the drum; a plurality of support portions movably connected to the drum and configured to support different portions of the tube, respectively; and a plurality of position maintaining portions respectively connected to the plurality of support portions, wherein the drum has an axial direction parallel to a direction in which the tube is pulled out through the outlet, wherein each of the plurality of support portions moves with respect to the drum in the axial direction while the tube is pulled out, and wherein each of the plurality of position maintaining portions is configured to apply a restoring force to each of the plurality of support portions so that each of the plurality of support portions moves to an initial position of each of the plurality of support portions with respect to the drum.

### BRIEF DESCRIPTION OF THE DRAWINGS

The above and/or other aspects will be more apparent by describing certain example embodiments with reference to the accompanying drawings, in which:

FIG. 1 is a perspective view of a fluid supply system according to various example embodiments;

FIG. 2 is a diagram illustrating the use of the fluid supply system according to various example embodiments;

FIG. 3 is a perspective view of a fluid supply device according to an example embodiment;

FIG. 4 is an enlarged view of area A of FIG. 3;

FIGS. 5A and 5B are diagrams schematically illustrating drawing-out and drawing-in of a tube of a fluid supply device according to an example embodiment;

FIG. 6 is a diagram schematically illustrating a fluid supply device according to an example embodiment;

FIG. 7 is a diagram schematically illustrating a fluid supply device according to an example embodiment;

FIG. 8 is a diagram schematically illustrating a fluid supply device according to an example embodiment;

FIGS. 9A and 9B are diagrams schematically illustrating drawing-out and drawing-in of a tube of a fluid supply device according to an example embodiment; and

FIGS. 10A and 10B are diagrams schematically illustrating drawing-out and drawing-in of a tube of a fluid supply device according to an example embodiment.

### DETAILED DESCRIPTION

The following structural or functional descriptions are exemplary to merely describe the example embodiments, and the scope of the example embodiments is not limited to the descriptions provided in the present specification. Various changes and modifications can be made thereto by those of ordinary skill in the art.

The terminology used herein is for the purpose of describing one example embodiment only and is not to be limiting to an example embodiment. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

When describing the example embodiments with reference to the accompanying drawings, like reference numerals refer to like constituent elements and a repeated description related thereto will be omitted. In the description of an example embodiment, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the example embodiments described above and an element having a common function. Unless otherwise mentioned, the descriptions on the example embodiments may be applicable to the following example embodiments and thus, duplicated descriptions will be omitted for conciseness.

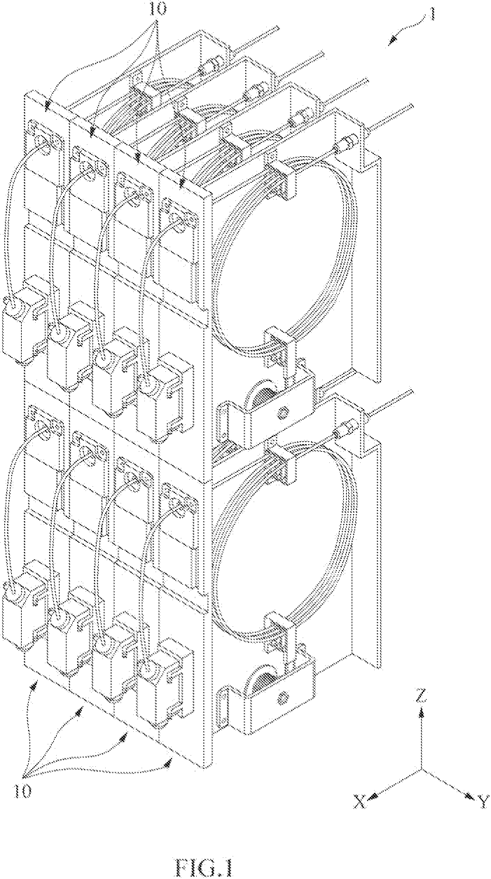

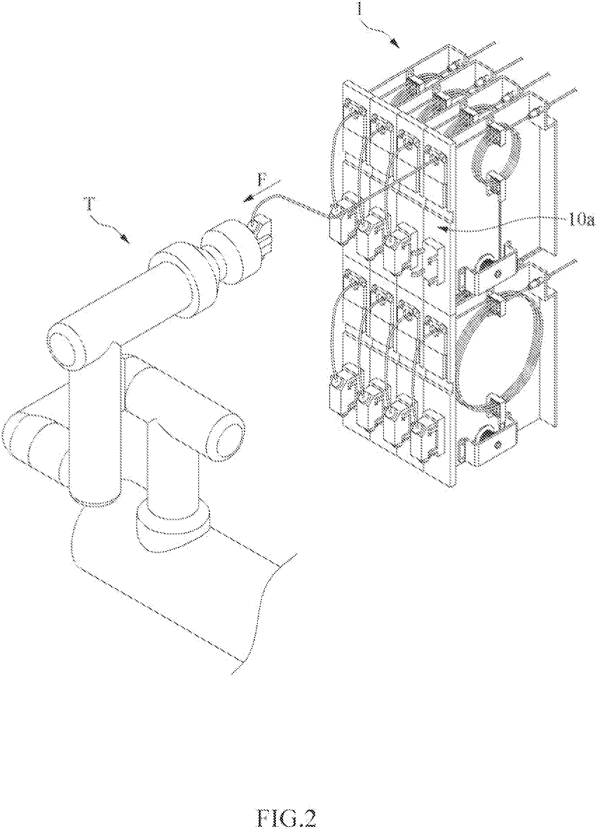

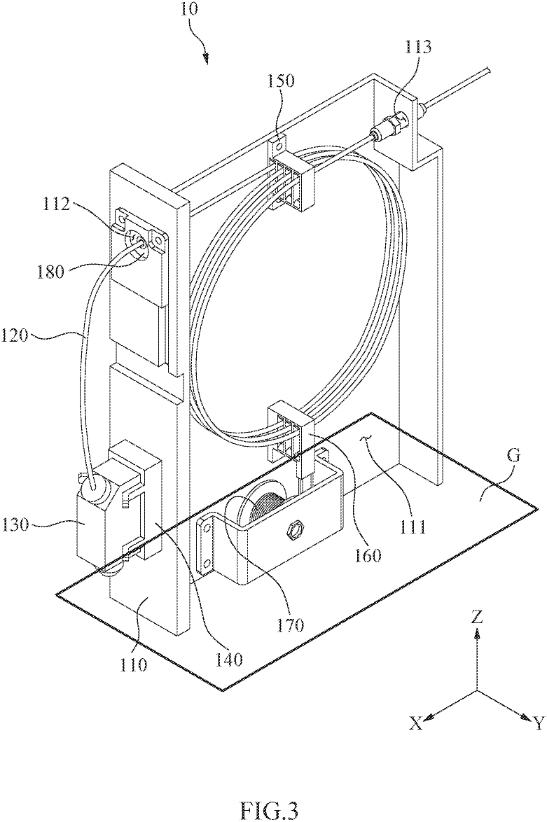

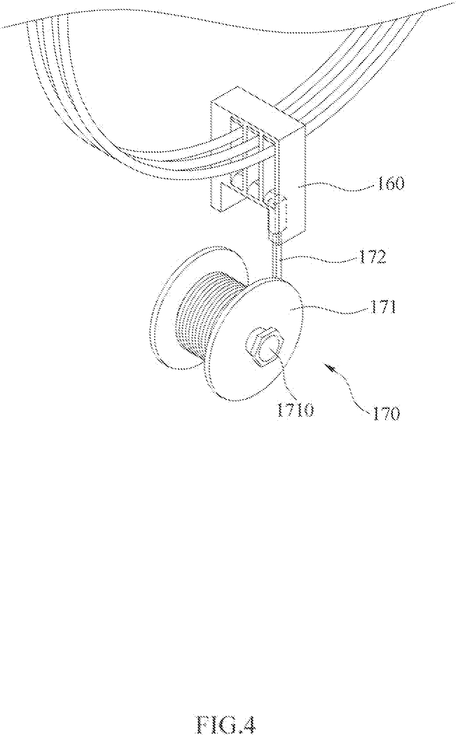

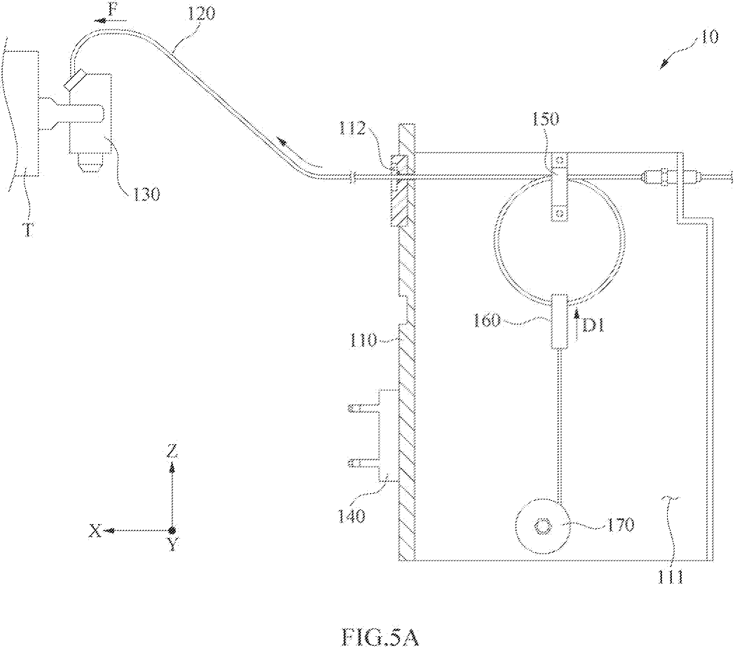

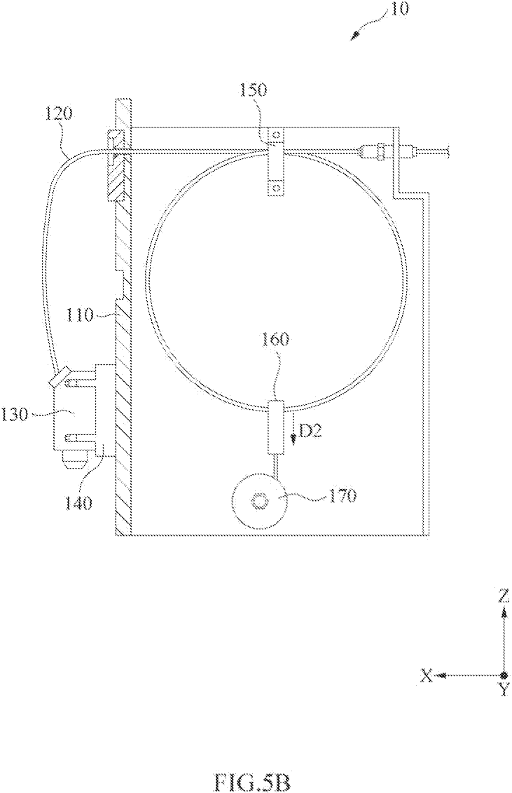

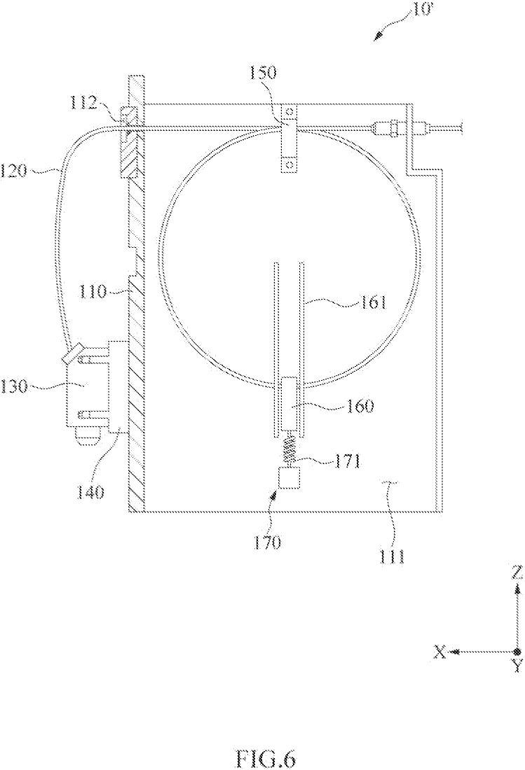

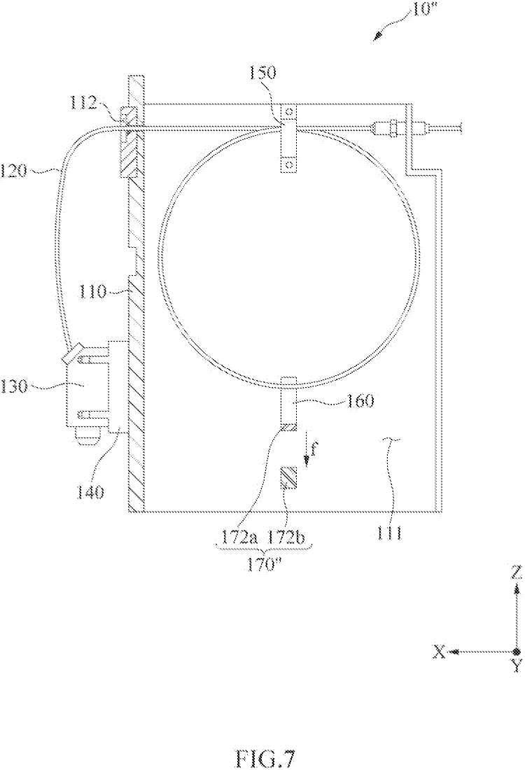

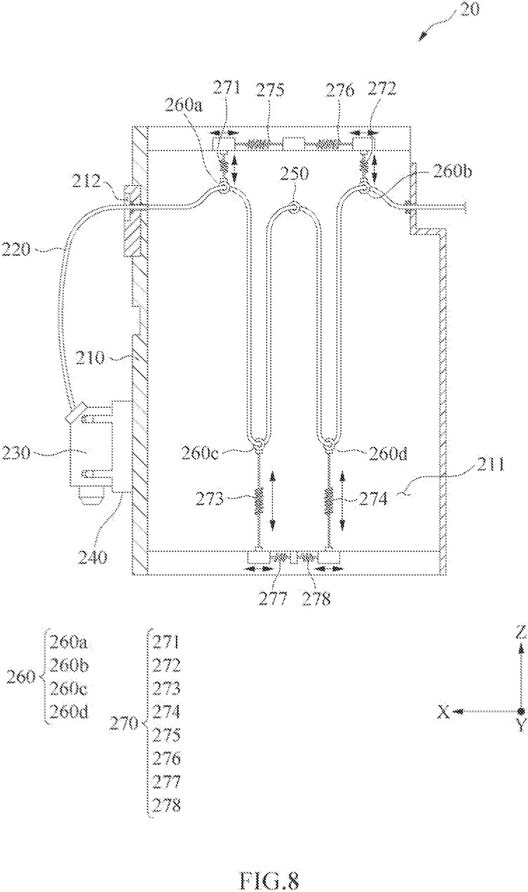

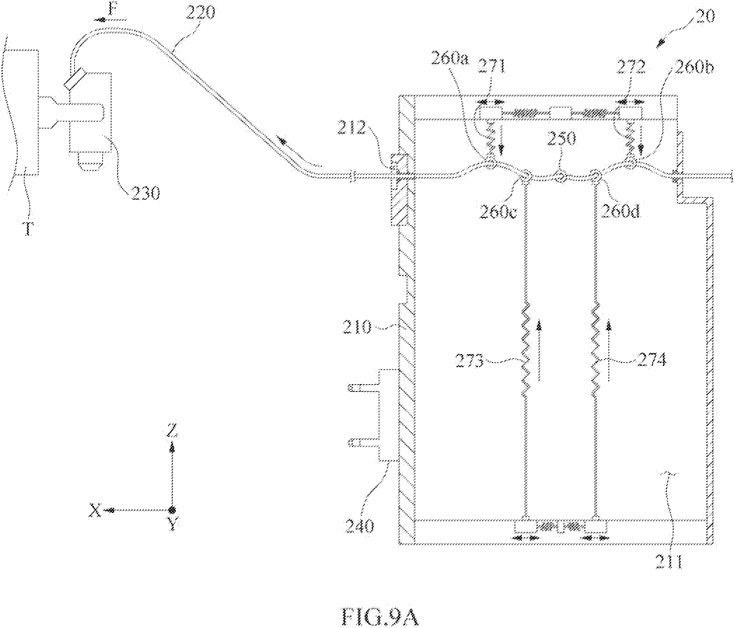

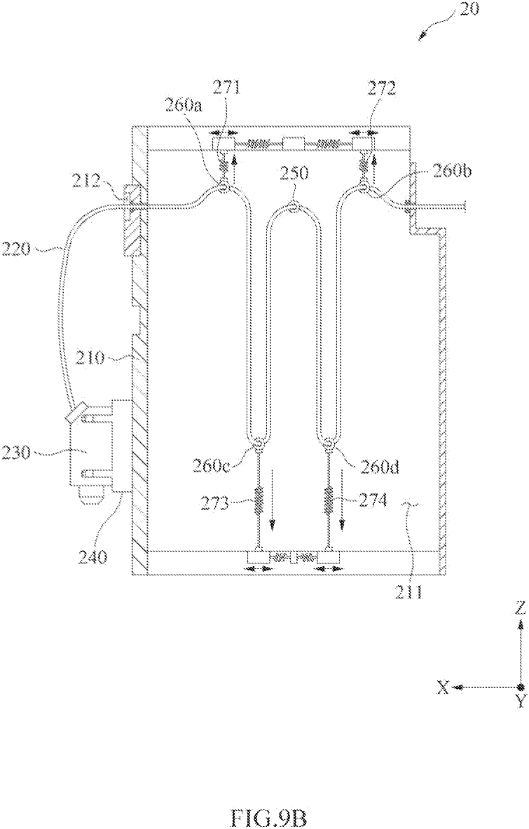

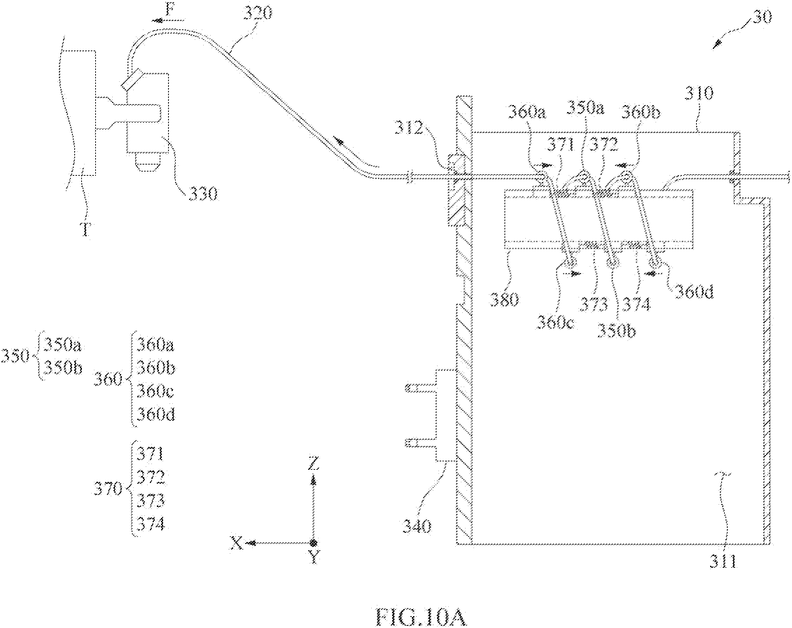

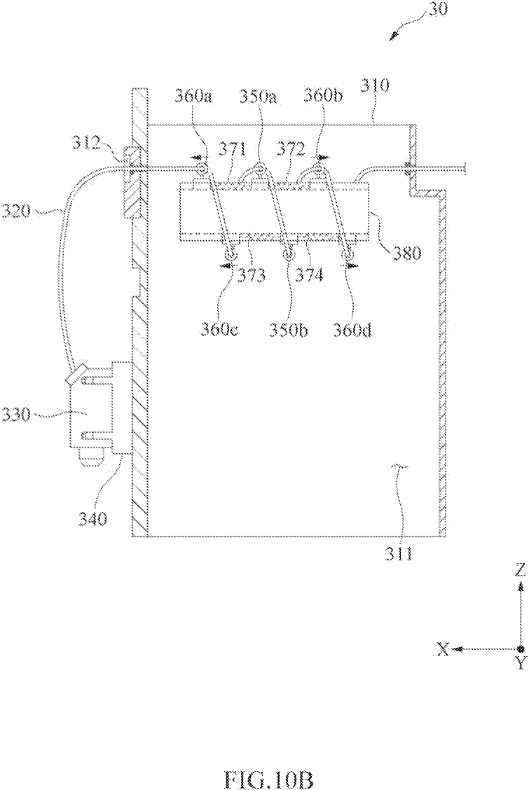

FIG. 1 is a perspective view of a fluid supply system according to various example embodiments, and FIG. 2 is a diagram illustrating the use of the fluid supply system according to various example embodiments.

Referring to FIGS. 1 and 2, a fluid supply system 1 may be used to supply various types of fluids. For example, the fluid supply system 1 may be used to supply a fluid used in various types of processes (e.g., a chemical process, a food-manufacturing process, a semiconductor-manufacturing process, etc.), or to transport or spray a liquid material. In an example embodiment, the fluid supply system 1 may selectively supply various types of fluids by separating supply lines. In an example embodiment, the fluid supply system 1 may include a plurality of fluid supply devices 10 capable of individually supplying a fluid.

In an example embodiment, the plurality of fluid supply devices 10 may be mutually and separably coupled to each other in a horizontal direction (e.g., a Y-axis) or vertical direction (e.g., a Z-axis), as shown in FIG. 1, to form the fluid supply system 1. The size of the fluid supply system 1 may be expanded or reduced by adding or removing a fluid supply device 10 depending on the type of fluid required for a process to which the fluid supply system 1 is applied.

In an example embodiment, the plurality of fluid supply devices 10 may supply a set fluid through a plurality of individual channels. The fluid supply devices 10 may be physically coupled to each other to form a single fluid supply system 1, while each of the fluid supply devices 10 individually forms a fluid supply line (or a fluid supply channel). Accordingly, in a process of using the fluid supply system 1, it may be possible to eliminate a problem that fluids supplied respectively by the fluid supply devices 10 are mixed.

In an example embodiment, each of the plurality of fluid supply devices 10 may include a housing (e.g., a housing 110 of FIG. 3) that forms an exterior, a tube (e.g., a tube 120 of FIG. 3) inside the housing allows fluid to flow through it, and a dispenser head (e.g., a dispenser head 130 of FIG. 3) attached to the of the tube. The tube of each of the fluid supply devices 10 may be stored in an internal storage space (e.g., a storage space 111 of FIG. 3) of the housing to be physically separated from tubes of other fluid supply devices 10 during use of the fluid supply system 1.

Referring to FIG. 2, the fluid supply system 1 may supply a process target fluid through a selected dispenser head of one of the fluid supply devices 10, which is selected to supply the process target fluid, among the multiple fluid supply devices 10. For example, to deliver a predetermined fluid to a target T, the dispenser head of a predetermined fluid supply device 10a may be selectively connected to the target T. In this example, the movement of the dispenser head may cause the tube inside the fluid supply device 10 to be pulled out and extended.

FIG. 3 is a perspective view of a fluid supply device according to an example embodiment, and FIG. 4 is an enlarged view of area A of FIG. 3, and FIGS. 5A and 5B are diagrams schematically illustrating drawing-out and drawing-in of a tube of a fluid supply device according to an example embodiment.

Referring to FIGS. 3 and 4, a fluid supply device 10 according to an example embodiment may include the housing 110, the tube 120, the dispenser head 130, a mounting portion (e.g., a mounting fixture or a mounting bracket) 140, a fixing portion 150, a support portion 160, and a position maintaining portion 170, a guide member 180, and a sensor.

In an example embodiment, the housing 110 may form the exterior of the fluid supply device 10, and may contain the storage space 111. An outer surface of the housing 110 has an outlet 112 and an opening 113 that connect the storage space 111 to the outside. In an example embodiment, the height of the outlet 112 and the opening 113 may be the same or substantially the same relative to the ground G (e.g., a base or a bottom support of the fluid supply device 10, or a surface on which the fluid supply device 10 placed). In an example embodiment, the housing 110 may be connected to a housing of another fluid supply device in either the vertical direction or the horizontal direction. In the present disclosure, two or more values are considered as being substantially the same when a difference between the two or more values is less than a predetermined value (e.g., 10 cm).

In an example embodiment, the tube 120 may allow fluid to flow through it. In an example embodiment, at least a portion of tube 120 may be positioned within the storage space 111 and may pass through the opening 113 and the outlet 112. In an example embodiment, a first end portion of the tube 120 may extend outward through the outlet 112, while a second end portion of the tube 120, located opposite to the first end portion of the tube 120, may extend outward through the opening 113. The second end portion may be connected to a tank in which a fluid is stored. In an example embodiment, the tube 120 may be formed of a flexible material that is bendable. In an example embodiment, the tube 120 may be extended or retracted through the outlet 112 or may return back to be stored in the storage space 111. The length and arrangement of the tube 120 in the storage space 111 may change depending on how much the tube 120 is extended or retracted through the outlet 112.

In an example embodiment, the dispenser head 130 may be connected to an end portion of the tube 120 that has passed through the outlet 112. In an example embodiment, the fluid flowing inside the tube 120 through the dispenser head 130 may be discharged to the outside. For example, the dispenser head 130 may be connected to a target (e.g., a pipe, a tank, etc.) and may supply the fluid inside the tube 120 to the target.

In an example embodiment, the housing 110 has the mounting portion 140 on the outer surface. The dispenser head 130 may be detached from the mounting portion 140 for use, and may be stored on the mounting portion 140 when not in use. The mounting portion 140 may serve as a storage location for the dispenser head 130 of the fluid supply device 10 when the dispenser head 130 is not used.

In an example embodiment, the fixing portion 150 may be disposed inside the housing 110 and may support at least a portion of the tube 120 in the storage space 111. The fixing portion 150 may support the tube 120 in a fixed position in the storage space. For example, the fixing portion 150 may include one or more openings through which the tube 120 may pass, and the tube 120 may be connected to the fixing portion 150 through the openings. In an example embodiment, a portion of the tube 120 supported by the fixing portion 150 may change. In an example embodiment, based on a height direction (e.g., a +Z-axis) with respect to the ground, a height of a portion of the tube 120 supported in the fixing portion 150 may substantially be the same as a height of a portion of the tube 120 at the outlet 112 and may be substantially the same. Based on the above structure, while the tube 120 is drawn out or drawn in through the outlet 112 the fixing portion 150 may assist the tube 120 to pass through the outlet 112 in a straight direction.

In an example embodiment, the support portion 160 may be in the storage space 111 and may support at least a portion of the tube 120 in the storage space 111. For example, the support portion 160 may include one or more openings and the tube 120 may be supported by the support portion 160 by passing through an opening formed in the support portion 160. In this example, a portion of the tube 120 supported by the support portion 160 may change according to the degree to which the tube 120 is drawn out. In an example embodiment, the portion of the tube 120 supported by the support portion 160 may be different from the portion of the tube 120 supported by the fixing portion 150. In an example embodiment, the support portion 160 may support the tube 120 and, at the same time, a position of the support portion 160 in the storage space 111 may change according to the drawing-out and drawing-in of the tube 120. In an example embodiment, the support portion 160 may support a portion of the tube 120 while the position changes in response to the movement of the tube 120. Therefore, in the process of drawing out and drawing in the tube 120, the support portion 160 may prevent the tube 120 in the storage space 111 from being twisted or tangled.

In an example embodiment, as the tube 120 is drawn out through the outlet 112, the position of the support portion 160 in the storage space 111 may change from an initial position to a position adjacent to the outlet 112. In an example embodiment, the support portion 160 may be at a position lower than the outlet 112, based on the height with respect to the ground. In this example, as the tube 120 inside the storage space 111 is drawn out through the outlet 112, the position of the support portion 160 in the height direction (e.g., a Z-axis) with respect to the ground may change. For example, as shown in FIG. 3, the support portion 160 may be at a lower height compared to the fixed portion 150, and as the tube 120 is drawn out through the outlet 112, the support portion 160 may move to be adjacent to the fixed portion 150 and the height of the support portion 160 relative to the ground may increase. However, the position change of the support portion 160 described above is an example according to an example embodiment, and the support portion 160 may move in a direction toward or away from the outlet 112 according to the degree to which the tube 120 is drawn out. For example, when the support portion 160 is at the same height as the outlet 112, the support portion 160 may move in the horizontal direction (e.g., the X-axis or Y-axis).

In an example embodiment, the position maintaining portion 170 may be connected to the support portion 160 and apply a restoring force to the support portion 160 such that the position of the support portion 160 may return to the initial position of the support portion 160. For example, when an external force for drawing out the tube 120 is removed, the position maintaining portion 170 may return the support portion 160 to the initial position. In this example, the support portion 160 may perform an operation of introducing the tube 120 drawn out to the inside of the storage space 111 by moving the tube 120 to the initial position while supporting the tube 120. In other words, when the tube 120 is drawn out by the external force, the position of the support portion 160 may change from the initial position to the position adjacent to the outlet 112, and when the external force is removed, such that the position of the support portion 160 may return to the initial position by the restoring force of the position maintaining portion 170. Based on the above structure, when the support portion 160 is at the initial position, the arrangement state of the tube 120 in the storage space 111 may be maintained substantially constant, thereby ensuring a regularity of an arrangement state of the tube 120 in the storage space 111.

In an example embodiment, as shown in FIG. 3, when the height of the support portion 160 with respect to the ground increases according to the drawn-out of the tube 120, that is, when the support portion 160 moves from the initial position in a direction opposite to the direction of gravity, the position maintaining portion 170 may return the support portion 160 to the initial position by applying a force in the direction of gravity to the support portion 160.

In an example embodiment, the position maintaining portion 170 may apply a restoring force to the support portion 160 in various ways. For example, the position maintaining portion 170 may apply a restoring force to the support portion 160 through at least one of an elastic force, the force of gravity, a magnetic force, an electromagnetic force, and an electric force.

In an example embodiment, the position maintaining portion 170 may include a rotating member 171 that rotates, a tension member 172 wound around the rotating member 171 and having an end portion connected to the support portion 160, and an actuator 1710 that rotates the rotating member 171.

In an example embodiment, the tension member 172 may rotate the rotating member 171 in one direction according to the movement of the support portion 160, for example, the movement of the support portion 160 as the tube 120 is drawn out. In this example, the actuator 1710 may rotate the rotating member 171 in the opposite direction after completely drawing out the tube 120, that is, in a state in which the external force for drawing out or pulling out the tube 120 is removed. Accordingly, the support portion 160 may return to the initial position through the tension member 172.

In an example embodiment, the actuator 1710 may be an electric motor that is connected to an axis of the rotating member 171 and that performs a rotation operation of the rotating member 171 through electric force. In this example, the reverse rotation of the rotating member 171 may be performed according to the operation of the electric motor. In another embodiment, the actuator 1710 may be a torsion spring connected to the axis of the rotating member 171. In this case, the torsion spring may store the elastic force in a process of rotating the rotating member 171 in one direction due to the movement of the support portion 160 and may act as a restoring force so that the rotating member 171 rotates in the reverse direction through the stored elastic force. The above-described method of the actuator 1710 may be an example, and the type and method of operating the actuator 1710 are not limited to the described example.

The guide member 180 may be located at the outlet 112 and may reduce a frictional force generated in the tube 120 passing through the outlet 112. The guide member 180, for example, may be formed of a low friction material, such as polytetrafluoroethylene (PTFE), polyimide, polyether-ether-ketone (PEEK), nylon, acetal, and the like, and may be adjacent to the outlet 112 to directly contact the outer surface of the tube 120, or may support the outer surface of the tube 120 passing through the outlet 112 in the form of a structure, such as a bearing.

In an example embodiment, a sensor may sense drawing-out or drawing-in of the tube 120. For example, the sensor may detect whether the tube 120 is normally drawn out or drawn in through the outlet 112 without being twisted or tangled. Various types of sensors, such as a magnetic sensor, a force sensor, a photo sensor, a limit switch, and a vision sensor, may be used, and the type of sensors is not limited to the examples listed above.

Referring to FIGS. 5A and 5B, the fluid supply device 10 may maintain a constant arrangement state of the tube 120 in the storage space 111 in a state in which the tube 120 is in the storage space 111, while guiding the drawing-out and drawing-in of the tube 120 according to the movement of the support portion 160.

For the dispenser head 130 to be connected to a target as shown in FIG. 5A, the tube 120 in the storage space 111 may be pulled out through the outlet 112 by an external force. In this example, the support portion 160 may move to a position adjacent to the outlet 112 while supporting a portion of the tube 120. For example, as shown in FIG. 5A, the height of the support portion 160 with respect to the ground may increase toward the outlet 112. In this example, the fixing portion 150 may assist the tube 120 to be drawn out in a straight direction through the outlet 112 by supporting the tube 120 at substantially the same position as the outlet 112.

When the external force that is pulling out the tube 120 is released, as shown in FIG. 5B, the support portion 160 may return to the initial position from the raised position of the support portion 160, due to the restoring force of the position maintaining portion 170. The support portion 160 may guide the previously drawn out tube 120 back into the storage space 111 while returning to the initial position in a state in which tube 120 is supported. When the support portion 160 returns to the initial position, the arrangement of the tube 120 in the storage space 111 may remain largely unchanged. Accordingly, it is possible to prevent the tube 120 from being tangled or twisted in the storage space 111, regardless of whether the tube 120 is being pulled out or pushed back in. For example, when the support portion 160 is returned to the initial position, and the tube 120 has been fully retracted into the storage space 111, the used dispenser head 130 can be stored by attaching the dispenser head 130 to the mounting portion 140.

FIG. 6 is a diagram schematically illustrating a fluid supply device according to an example embodiment.

Referring to FIG. 6, a fluid supply device 10′ according to an example embodiment includes a housing 110, a tube 120, a dispenser head 130, a mounting portion 140, a fixing portion 150, a support portion 160, a guide rail 161, and a position maintaining portion 170.

In an example embodiment, the housing 110 may have a storage space 111, in which at least a portion of the tube 120 is disposed, and an outlet 112, which is formed in an outer surface of the housing 110 and through which the tube 120 is drawn or pulled out from the storage space 111. The dispenser head 130 may be connected to a first end portion of the tube 120 extending to the outside of the outlet 112, and the mounting portion 140, to which the dispenser head 130 is detachably mounted, may be formed in the outer surface of the housing 110. In an example embodiment, at least a portion of the tube 120 in the storage space 111 may be supported by the fixing portion 150 and the support portion 160, respectively. The fixing portion 150 may support the tube 120 at a fixed position, and a position of the support portion 160 in of the storage space 111 may change from the initial position according to the drawing out of the tube 120.

In an example embodiment, the guide rail 161 configured to guide the movement of the support portion 160 may be disposed inside the storage space 111. The position of the support portion 160 may change while moving along the guide rail 161.

In an example embodiment, the position maintaining portion 170 may apply a restoring force to return the support portion 160 to the initial position through an elastic force. This is achieved through the user of an elastic member 171 of the position maintaining portion 170 that is connected to the support portion 160. In an example embodiment, one end portion of the elastic member 171 may be fixed at a fixed position in the storage space 111, and the other end portion of the elastic member 171 may be connected to the support portion 160. The elastic member 171 may store an elastic force as the support portion 160 moves from an initial position and apply a restoring force so that the support portion 160 returns to the initial position through the stored elastic force. For example, as the tube 120 is pulled out, the height of the support portion 160 relative to the ground increases, as shown in FIG. 6. This movement of the support portion 160 causes the elastic member 171 to store the elastic force, which then creates a restoring force to return the support portion 160 to the initial position when the external force pulling the tube 120 is released.

FIG. 7 is a diagram schematically illustrating a fluid supply device according to an example embodiment.

Referring to FIG. 7, a fluid supply device 10″ according to an example embodiment may include a housing 110, a tube 120, a dispenser head 130, a mounting portion 140, a fixing portion 150, a support portion 160, a guide rail 161, and a position maintaining portion 170″.

In an example embodiment, the position maintaining portion 170″ may apply a restoring force to the support portion 160 through a magnetic force. For example, the position maintaining portion 170″ may include a first magnetic member 172a connected to the support portion 160 and a second magnetic member 172b magnetically coupled to the first magnetic member 172a. In an example embodiment, the first magnetic member 172a and the second magnetic member 172b may apply a magnetic force to each other so that the support portion 160 may be positioned at an initial position. For example, the first magnetic member 172a and the second magnetic member 172b may apply a force to each other, so that the support portion 160 connected to the first magnetic member 172a returns to the initial position.

FIG. 8 is a diagram schematically illustrating a fluid supply device according to an example embodiment, and FIGS. 9A and 9B are diagrams schematically illustrating operations of drawing-out (e.g., pulling-out) and drawing-in (e.g., pushing-in) a tube of a fluid supply device according to an example embodiment.

Referring to FIG. 8, a fluid supply device 20 according to an example embodiment may include a housing 210, a tube 220, a dispenser head 230, a mounting portion 240, a fixing portion 250, a plurality of support portions 260 and a position maintaining portion 270.

In an example embodiment, the housing 210 may have a storage space 211 inside which at least a portion of the tube 220 is disposed, and an outlet 212 for the tube 220 to be drawn out from the storage space 211 may be formed on an outer surface of the housing 210. The dispenser head 230 may be connected to a first end portion of the tube 220 extending outside the outlet 212, and the mounting portion 240, to which the dispenser head 230 is detachably mounted, may be formed on the outer surface of the housing 210.

In an example embodiment, the fixing portion 250 may support at least a portion of the tube 220 at a fixed position inside the storage space 211. For example, a portion of the tube 220 supported by the fixing portion 250 may be substantially at the same height as a portion of the tube 220 at the outlet 212.

In an example embodiment, the plurality of support portions 260 may be at different positions in the storage space 211 and support different portions of the tube 220, respectively. A position of each of the plurality of support portions 260 may change in the storage space 211 according to drawing-out and drawing-in of a tube the tube 220 through the outlet 212. For example, a position of each of the plurality of support portions 260 may change from an initial position thereof to a position adjacent to the outlet 212 according to the drawing out of the tube 220. In an example embodiment, as shown in FIG. 8, the plurality of support portions 260 may be at different heights from the outlet 212 with respect to the ground (e.g., the Z-axis). For example, the plurality of support portions 260 may include a first support portion 260a and a second support portion 260b positioned higher than the outlet 212, and a third support portion 260c and a fourth support portion 260d positioned lower than the outlet 212. In this example, the tube 220 may be positioned in the storage space 211 to be connected to the plurality of support portions 260 and the fixing portion 250 in an alternating manner.

In an example embodiment, a plurality of position maintaining portions 270 may be respectively connected to the plurality of support portions 260. A position maintaining portion 270 may apply a restoring force to a support portion 260 connected to the position maintaining portion 270 to return the support portion 260 to an initial position.

In an example embodiment, the plurality of position maintaining portions 270 may return positions of the support portions 260 in a height direction to initial positions of the support portions 260. For example, the plurality of position maintaining portions 270 may include a first position maintaining portion 271 connected to the first support portion 260a, a second position maintaining portion 272 connected to the second support portion 260b, a third position maintaining portion 273 connected to the third support portion 260c, and a fourth position maintaining portion 274 connected to the fourth support portion 260d. In an example embodiment, the first position maintaining portion 271, the second position maintaining portion 272, the third position maintaining portion 273, and the fourth position maintaining portion 274 may return positions of the first support portion 260a, the second support portion 260b, the third support portion 260c, and the fourth support portion 260d to initial positions. In an example embodiment, the plurality of position maintaining portions 270 may be connected to each of the support portions 260 and a position in the horizontal direction (e.g., the X-axis) of each connected support portion may be returned to the initial position. For example, the plurality of position maintaining portions 270 may include a fifth position maintaining portion 275 connected to the first support portion 260a and applying a restoring force in the horizontal direction, a sixth position maintaining portion 276 connected to the second support portion 260b and applying a restoring force in the horizontal direction, a seventh position maintaining portion 277 connected to the third support portion 260c and applying a restoring force in the horizontal direction, and an eighth position maintaining portion 278 connected to the fourth support portion 260d and applying a restoring force in the horizontal direction. The number, type, arrangement state, and connection state described above of the support portions 260 and the position maintaining portions 270 are merely examples for convenience of description, and the number, arrangement, and connection structure of the support portions 260 and the position maintaining portions 270 are not limited thereto. In addition, although the diagram shows that the position maintaining portion 270 applies a restoring force to the support portion 260 through a spring operation for the convenience of description, a method of operating the position maintaining portions 270 is not limited thereto.

Referring to FIGS. 9A and 9B, the fluid supply device 20 may guide the drawing-out or drawing-in of the tube 220 through the operation of the plurality of support portions 260 and the position maintaining portions 270, and also, may maintain a constant arrangement state of the tube 220 in the storage space 211 in a state of the tube 220 is completely drawn in, for example, a state in which each of the plurality of the support portions 260 is at the initial position.

In a process in which the tube 220 is pulled out by an external force as shown in FIG. 9A, the plurality of support portions 260 may move from the initial position to a position adjacent to the outlet 212 while supporting the tube 220. For example, the first support portion 260a and the second support portion 260b may move in the horizontal direction towards the outlet 212 while lowering in height. Meanwhile, the third support portion 260c and the fourth support portion 260d may move vertically in the height direction towards the outlet 212 while rising in height. The length of the tube 220 that can be pulled out may be secured by adjusting the arrangement state of the tube 220 inside the storage space 211 based on the movement of the support portions 260.

When an external force for pulling out the tube 220 is released as shown in FIG. 9B, the plurality of support portions 260 may return to the initial positions thereof by receiving restoring forces by the position maintaining portions 270 respectively connected to the support portions 260. For example, the first support portion 260a may be returned to an initial position thereof in the height direction and the horizontal direction by the first position maintaining portion 271 and the fifth position maintaining portion 275, and the second support portion 260b may be returned to an initial position thereof in the height direction and the horizontal direction by the second position maintaining portion 272 and the sixth position maintaining portion 276. The third support portion 260c may be returned to an initial position thereof in the height direction and the horizontal direction by the third position maintaining portion 273 and the seventh position maintaining portion 277, and the fourth support portion 260d may be returned to an initial position thereof in the height direction and the horizontal direction by the fourth position maintaining portion 274 and the eighth position maintaining portion 278. The tube 220 drawn out according to returning to the initial positions of the plurality of support portions 260 may be introduced into the storage space 211. Regardless of the drawing-out and drawing-in of the tube 220, the arrangement state of the tube 220 inside the storage space 211 may be maintained substantially constant in a state in which each of the plurality of support portions 260 is at the initial position.

FIGS. 10A and 10B are diagrams schematically illustrating drawing-out and drawing-in of a tube of a fluid supply device according to an example embodiment.

Referring to FIGS. 10A and 10B, a fluid supply device 30 according to an example embodiment may include a housing 310, a tube 320, a dispenser head 330, a mounting portion 340, a drum 380, a fixing portion 350, a support portion 360, and a position maintaining portion 370.

In an example embodiment, the housing 310 may have a storage space 311 formed therein and in which at least a portion of the tube 320 is disposed, and an outlet 312, which is formed on an outer surface of the housing 310 and through which the tube 320 is pulled out from the storage space 311 or pulled back in the storage space 311. In an example embodiment, at least a portion of the tube 320 may be in the storage space 311. The tube 320 may be formed of a flexible material. The dispenser head 330 may be connected to an end portion of the tube 320 extending outwardly from the outlet 312, and the mounting portion 350, to which the dispenser head 330 is detachably mounted, may be formed on the outer surface of the housing 310.

In an example embodiment, the drum 380 may be disposed in the storage space 311. At least a portion of the tube 320 in the storage space 311 may be wound around an outer surface of the drum 380. In an example embodiment, the drum 380 may be formed in a cylindrical shape, and an axial direction of the drum 380 perpendicular to a cross section may be arranged parallel to a withdrawal direction (e.g., the X-axis) of the tube 320.

In an example embodiment, a plurality of fixing portions 350 and plurality of support portions 360 may be provided and may be connected to the drum 380. In an example embodiment, the fixing portion 350 may be fixed to the outer surface of the drum 380 and may support at least a portion of the tube 320 wound around the drum 380. One or more fixing portions 350 may be provided. For example, the fixing portion 350 may include a first fixing portion 350a and a second fixing portion 350b.

In an example embodiment, a plurality of support portions 360 may be provided and movably connected to the drum 380. The plurality of support portions 360 may respectively support different portions of the tube 320 wound around the drum 380. For example, the tube 320 wound around the drum 380 may be connected to the plurality of support portions 360 and one or more fixing portions 350 in an alternating manner. In an example embodiment, each of the plurality of support portions 360 may move on the drum 380 in the axial direction according to the drawing-out and drawing-in of the tube 320. In an example embodiment, while the tube 320 is pulled out through the outlet 312, the plurality of support portions 360 may move in the axial direction from the initial positions thereof.

In an example embodiment, the plurality of support portions 360 may include a first support portion 360a, a second support portion 360b, a third support portion 360c, and a fourth support portion 360d. In this example, the first support portion 360a and the second support portion 360b may be arranged on the same line along a first line parallel to the axial direction, and the third support portion 360c and the fourth support portion 360d may be arranged on the same line along a second line parallel to the axial direction. In this example, the first fixing portion 350a may be positioned between the first support portion 360a and the second support portion 360b, and the second fixing portion 350b may be positioned between the third support portion 360c and the fourth support portion 360d. However, the number of support portions 360 and the number of fixing portions 350, and an arrangement relationship of the support portions 360 and the fixing portions 350 are merely examples, and the example embodiments are not limited thereto.

In an example embodiment, a plurality of position maintaining units 370 may be provided and respectively connected to the plurality of support portions 360. A position maintaining portion 370 may apply a restoring force to a support portion 360 connected to the position maintaining portion 370 so that the support portion 360 may move to an initial position with respect to the drum 380. For example, the position maintaining portion 370 may include a first position maintaining portion 371 applying a restoring force to a first support portion 360a, a second position maintaining portion 372 applying a restoring force to a second support portion 360b, a third position maintaining portion 373 applying a restoring force to a third support portion 360c, and a fourth position maintaining portion 374 applying a restoring force to a fourth support portion 360d.

When the tube 320 is pulled out from the storage space 311 by an external force as shown in FIG. 10A, the plurality of support portions 360 may move in a direction of decreasing the length of the tube 320 wound around the drum 380. For example, the first support portion 360a and the second support portion 360b may move to be adjacent to a first fixing portion 350a, and the third support portion 360c and the fourth support portion 360d may move to be adjacent to a second fixing portion 350b. For example, the length of the tube 320 wound around the drum 380 may be reduced by decreasing a gap between the plurality of support portions 360, thereby securing the length of the tube 320 that may be pulsed out.

As shown in FIG. 10B, when an external force for drawing out the tube 320 is removed, each of the plurality of support portions 360 may return to an initial position thereof with respect to the drum 380 through restoring forces of the plurality of position maintaining portions 370. For example, the first support portion 360a and the second support portion 360b may move in a direction away from the first fixing portion 350a, and the third support portion 360c and the fourth support portion 360d may move in a direction away from the second fixing portion 350b. Accordingly, while the length of the tube 320 returns to an initial state, the tube 320 wound around the drum 380 may be introduced into the storage space 311. Based on the above structure, a regularity of an arrangement of an arrangement of the tube 320 in the storage space 311 may be ensured regardless of the drawing-out and drawing-in of the tube 320.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

What is claimed is:

1. A fluid supply device comprising:
a tube comprising a flexible material and configured to allow a fluid to flow through the tube;
a housing comprising a storage space configured to store at least a portion of the tube, and an outlet which allows the tube to extend from the storage space;
a support portion configured to support at least a portion of the tube in the storage space, and configured to move from an initial position of the support portion towards the outlet based on a degree of extension of the tube from the outlet; and
a position maintaining portion connected to the support portion and configured to apply a restoring force to the support portion to return the support portion to the initial position.

2. The fluid supply device of claim 1, further comprising:
a fixing portion configured to support at least a portion of the tube in a fixed position in the storage space,
wherein the fixing portion and the support portion are configured to support different portions of the tube, respectively.

3. The fluid supply device of claim 2, wherein the support portion is configured to move towards the fixing portion while the tube is being pulled out through the outlet.

4. The fluid supply device of claim 2, wherein a height of a portion of the tube supported by the fixing portion from a ground is equal to a height of the outlet from the ground.

5. The fluid supply device of claim 1, wherein the support portion is disposed lower than the outlet from a ground.

6. The fluid supply device of claim 5, wherein, when the tube is pulled out though the outlet,
the support portion rises from the initial position in a direction opposite to a direction of gravity, and
the position maintaining portion is configured to apply a force to the support portion in the direction of gravity.

7. The fluid supply device of claim 1, wherein
the position maintaining portion comprises an elastic member connected to the support portion, and
the elastic member is configured to store an elastic force while the support portion moves from the initial position and apply the restoring force to the support portion to return the support portion to the initial position through the elastic force.

8. The fluid supply device of claim 1, wherein the position maintaining portion comprises:
a first magnetic member connected to the support portion; and
a second magnetic member magnetically coupled to the first magnetic member,
wherein the first magnetic member and the second magnetic member are configured to apply a magnetic force to each other to return the support portion to the initial position.

9. The fluid supply device of claim 1, wherein the position maintaining portion comprises:
a rotating member configured to rotate;
a tension member wound around the rotating member and connected to the support portion; and
an actuator connected to the rotating member and configured to rotate the rotating member to return the support portion to the initial position.

10. The fluid supply device of claim 1, further comprising a plurality of support portions, wherein
the plurality of support portions are configured to move from initial positions of the plurality of support portions towards the outlet while supporting different portions of the tube in a process of drawing out the tube, and
the plurality of support portions are respectively connected to a plurality of position maintaining portions configured to return the plurality of support portions to the initial positions of the support portions.

11. The fluid supply device of claim 1, further comprising a guide rail provided in the storage space and configured to guide a movement of the support portion.

12. The fluid supply device of claim 1, further comprising:
a dispenser head connected to a first end portion of the tube; and
a mounting portion which is provided on an outer surface of the housing and on which the dispenser head is mounted.

13. The fluid supply device of claim 1, further comprising a guide member disposed at the outlet and configured to reduce a frictional force caused by a movement of the tube through the outlet.

14. The fluid supply device of claim 1, further comprising a sensor configured to sense a movement of the tube that is pulled out and pulled in through the outlet.

15. The fluid supply device of claim 1, wherein the housing further comprises an opening provided on an outer surface of the housing and through which the tube extends from the storage space to an outside, wherein the opening is at a same height as the outlet from a ground.

16. A fluid supply system comprising:
a plurality of fluid supply devices detachably interconnected with each other in a horizontal direction or a vertical direction and configured to individually supply a fluid,
wherein each of the plurality of fluid supply devices comprises:
a tube comprising a flexible material, and configured to allow the fluid to flow through the tube;
a dispenser head connected to an end portion of the tube;
a housing comprising a storage space configured to store at least a portion of the tube, and an outlet which allows the tube to extend from the storage space or retracted into the storage space from an outside;
a support portion configured to support a portion of the tube in the storage space, and configured to move based on a degree of extension of the tube from the outlet; and
a position maintaining portion connected to the support portion and configured to apply a restoring force to the support portion to return a portion of the tube pulled out to the outside is retracted into the storage space.

17. The fluid supply system of claim 16, wherein,
when the tube is pulled out from the storage space by an external force, the support portion is configured to move from an initial position of the support portion toward the outlet, and
when the external force is released, the support portion is configured to move to the initial position by the restoring force of the position maintaining portion.

18. The fluid supply system of claim 16, wherein the position maintaining portion is configured to apply the restoring force to the support portion through at least one of an elastic force, the gravity, a magnetic force, an electromagnetic force, and an electric force.

19. The fluid supply system of claim 16, wherein
each of the plurality of fluid supply devices further comprises a fixing portion positioned in the storage space and configured to support at least a portion of the tube at a different position from the support portion, and
the fixing portion is configured to support the tube in a fixed position in the storage space.

20. A fluid supply device comprising:
a tube;
a dispenser head connected to an end portion of the tube;
a housing configured to store the tube, and comprising an outlet that allows the tube to be pulled out from and pushed back into the housing;
a drum configured to hold at least a portion of the tube being wound around an outer surface of the drum;
a plurality of support portions movably connected to the drum and configured to support different portions of the tube, respectively; and
a plurality of position maintaining portions respectively connected to the plurality of support portions,
wherein the drum has an axial direction parallel to a direction in which the tube is pulled out through the outlet,
wherein each of the plurality of support portions moves with respect to the drum in the axial direction while the tube is pulled out, and
wherein each of the plurality of position maintaining portions is configured to apply a restoring force to each of the plurality of support portions so that each of the plurality of support portions moves to an initial position of each of the plurality of support portions with respect to the drum.
